(19) United States
(12) Patent Application Publication
(10) Pub. No.: US 2023/0104588 A1
(43) Pub. Date: Apr. 6, 2023

(54) PRINTER PICK TIRE CLEANING

(71) Applicant: Hewlett-Packard Development Company, L.P., Spring, TX (US)

(72) Inventors: Jeffrey Alan Sheadel, Vancouver, WA (US); Keith Jariabka, Vancouver, WA (US); Nathan Adamski, Vancouver, WA (US); John T.E. Myers, Vancouver, WA (US)

(21) Appl. No.: 17/908,304

(22) PCT Filed: Jun. 10, 2020
(86) PCT No.: PCT/US2020/037071

§ 371 Date: Aug. 31, 2022

(51) Int. Cl. B41J 29/17; B65H 3/06

(52) U.S. Cl. CPC B41J 29/17; B65H 3/06; B65H 2301/531; B65H 2301/532; B65H 2801/06

(57) ABSTRACT

Example methods for cleaning a pick tire of a printer are disclosed, along with systems that may be used to carry out the disclosed methods. In an example, the method includes advancing print media from a print media storage tray with a pick tire disposed within a printer. In addition, the method includes stopping the advancement of the print media. Further, the method includes rotating the pick tire on the print media to clean the pick tire.

### BACKGROUND

A printer may draw print media from a print media storage tray so as to feed the print media toward a printing assembly for the deposition of images, words, graphics, etc. (collectively referred to herein as “images”) thereon. In some instances, a roller known as a “pick tire” may initially engage with the print media in order to draw the print media from the print media storage tray.

### BRIEF DESCRIPTION OF THE DRAWINGS

Various examples will be described below referring to the following figures:

FIG. 1 is a schematic view of a printer according to some examples;

FIGS. 2 and 3 are schematic views of the printer of FIG. 1 according to some examples; and

FIGS. 4 and 5 are flow charts of methods of cleaning a pick tire of a printer according to some examples.

### DETAILED DESCRIPTION

A printer may utilize a pick tire to engage with and therefore draw print media from a print media storage tray so that the printing of images on the print media may be performed. During operations, the pick tire may collect dust, debris, printing agent (e.g., toner, liquid printing agent, etc.) (collectively referred to herein as “debris”) thereon, such that a coefficient of friction for the pick tire may be reduced. As a result of the accumulated debris, the contact friction between the pick tire and the print media may be reduced so that an ability of the pick tire to move print media out of the print media storage tray is diminished. In addition, depending on the type of the debris deposited on the pick tire, it is possible that streaks, lines or other undesirable marks may be deposited onto the print media by the pick tire during a printing operation.

Accordingly, examples disclosed herein include systems and related methods for cleaning a pick tire. In some examples, the systems and methods may determine a pick tire condition parameter, and then, based on the pick tire condition parameter, initiate a cleaning operation whereby the pick tire is intentionally rotated along a surface of the print media so as to remove debris from the pick tire. Thus, through use of the examples disclosed herein, a pick tire may be regularly cleaned so as to maintain an acceptable coefficient of friction for the pick tire, and to avoid un-controlled marking (e.g., with debris from the pick tire) of the print media during printing operations.

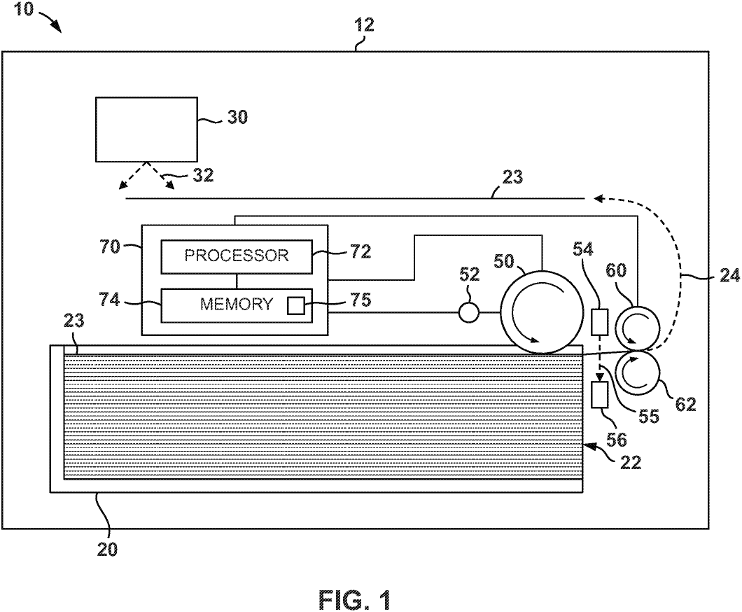

Referring now to FIG. 1, a printer 10 according to some examples disclosed herein is shown. Generally speaking, printer 10 includes a housing 12, a print media storage tray 20, and a printing assembly 30. The print media storage tray 20 and printing assembly 30 are disposed within the housing 12.

The print media storage tray 20 (or more simply “storage tray 20”) may hold a stack 22 of print media 23 therein. In some examples, the print media 23 may comprise pieces of paper that are laid on top of one another within storage tray 20 to form stack 22.

Printing assembly 30 includes any suitable collections of components that are to deposit printing agent 32 onto print media 23 so as to form images thereon. In some instances, the printing agent 32 may comprise a liquid printing agent (e.g., ink). Thus, in some examples, printer 10 may comprise a so-called “ink-jet” printer. In some examples, printing agent 32 may comprise a non-liquid printing agent (e.g., toner). Thus, in some examples, printer 10 may comprise a so-called “laser-jet printer.” Still other examples of printing agent are contemplated beyond those specific examples listed herein, so that no desire to limit the disclosed examples to certain types or classes of printers should be interpreted from this description.

Referring still to FIG. 1, printer 10 also includes a plurality of rollers disposed within housing 12 that are to guide print media 23 from storage tray 20 to printing assembly 30 along a print media path 24. In the depiction of FIG. 1, some of these rollers are specifically depicted; however, it should be appreciated that in some examples, printer 10 may include a number of rollers disposed at various locations along the print media path 24.

As shown in FIG. 1, the plurality of rollers within the printer 10 includes a pick tire 50 adjacent the stack 22 of print media 23 within storage tray 20, and a pair of second rollers 60, 62 immediately downstream of the pick tire 50 along the print media path 24. As used herein, the terms “downstream” and “upstream” are used to refer to the arrangement of components and features within a printer (e.g., printer 10) with respect to the “flow” of print media (e.g., print media 23) therethrough during operations. Thus, if a first component of such a device receives print media after it is output from a second component of the printer during operations, then the first component may be said to be “downstream” of the second component and the second component may be said to be “upstream” of the first component.

During a printing operation, pick tire 50 may engage with print media 23 within stack 22 and advance print media 23 toward second rollers 60, 62. The print media 23 is then pinched between the second rollers 60, 62 so that as second rollers 60, 62 rotate, the print media 23 is advanced further along print media path 24 toward printing assembly 30.

Referring still to FIG. 1, printer 10 may also include or be coupled to a controller 70. Generally speaking, the controller 70 includes a processor 72 and a memory 74. The processor 72 (e.g., microprocessor, central processing unit (CPU), or collection of such processor devices, etc.) executes machine-readable instructions 75 provided on memory 74 (e.g., non-transitory machine-readable medium). The memory 74 may comprise volatile storage (e.g., random access memory (RAM)), non-volatile storage (e.g., flash storage, etc.), or combinations of both volatile and non-volatile storage. Data consumed or produced by the processor 72 as it executes the machine-readable instructions 75 can also be stored on memory 74. In some instances, control assembly 70 may be incorporated within a general control assembly of the printer 10, or may be a stand-alone control assembly for controlling a pick tire cleaning operation (described in more detail below).

During operations, controller 70 may assess a pick tire condition (e.g., such as whether the pick tire 50 is wholly or partially covered with debris) and may initiate and perform a pick tire cleaning operation based on the pick tire condition. As used herein, a pick tire condition generally refers to how much debris is accumulated on the pick tire (e.g., pick tire 50). In particular, in some examples, controller 70 may determine a pick tire condition parameter (or a plurality of pick tire condition parameters) for determining whether a pick tire cleaning operation is warranted. As used herein, a “pick tire condition parameter” refers to any value, variable, item, determination, etc. that may provide an indication of the pick tire condition. Thus, a pick tire condition parameter may provide an indication that debris has built up on the pick tire 50 so that the ability of pick tire 50 to move print media 23 from storage tray 20 toward second rollers 60, 62 and print media path 24 is unacceptably diminished. In the following description, a number of example pick tire condition parameters are described that may be determined and utilized by the controller 70 during operations to inform whether a pick tire cleaning operation (described in more detail below) is warranted, and/or to determine a feature or features of a pick tire cleaning operation.

In some examples, a pick tire condition parameter may comprise a number of print jobs or page picks of print media that have been performed since a previous pick tire cleaning operation or other event (e.g., such as an initial start-up of the printer 10). As used herein, the term “print job” refers to the operation of a printer (e.g., printer 10) to print images on print media (e.g., as requested by a user). A single print job may comprise printing images on a single piece of print media 23 or a plurality of pieces of print media 23 (e.g., such as when printing a multiple page document). In addition, as used herein, the term “page pick” may refer to the sequence of events whereby a pick tire (e.g., pick tire 50) engages with a piece of print media (e.g., print media 23) and advances that print media out of a print media storage tray (e.g., storage tray 20). Thus, within a single print job, a pick tire may perform one page pick (e.g., when a single piece of print media 23 is being printed on for the print job) or may perform a plurality of page picks (e.g., when multiple pieces of print media 23 are being printed on for the print job).

Accordingly, in some examples controller 70 may keep count of how many print jobs and/or page picks have been performed since the last pick tire cleaning operation or another event (e.g., such as or since an initial start-up of printer 10), and once a predetermined number of print jobs and/or page picks has been completed, controller 70 may initiate a pick tire cleaning operation (or issue a command to perform a pick tire cleaning operation at a later time).

Without being limited to this or any other theory, it may be assumed that the pick tire 50 may accumulate debris at an average rate over a period of use. Thus, one may estimate the average number of print jobs or page picks that may be performed before the pick tire accumulates an unacceptable amount of debris. Various assumptions may be made in order to estimate the print job or page pick thresholds that may be aimed at achieving a desired level of cleanliness of the pick tire 50 during operations.

In some examples, a pick tire condition parameter may comprise a value of torque that is experienced by the pick tire 50 during a printing operation (e.g., such as during a page pick). For instance, as previously described, pick tire 50 may engage with print media 23 while rotating so as to move or advance print media 23 out of storage tray 20, toward second rollers 60, 62. Thus, frictional forces between the pick tire 50 and print media 23 may result in a torque transferred from the print media 23 to the pick tire 50 during these operations. As a result, during operations, one may expect to see a minimum amount of torque transferred to the pick tire 50 (or shaft or motor coupled thereto) during a page pick that corresponds with a normal or expected movement of print media 23. As debris is accumulated along the pick tire 50, and a frictional force between the pick tire 50 and print media 23 is reduced, pick tire 50 may begin to slide along the print media 23 so that the torque transferred to the pick tire 50 is reduced.

Accordingly, in some examples, controller 70 may be coupled to a torque sensor 52 (e.g., strain gauge, etc.) that detects, measured, estimates, etc. a torque (or value indicative thereof) experienced by the pick tire 50 (or shaft, motor, etc. coupled thereto) during operations. If the detected value of torque falls below a predetermined threshold, then controller 70 may determine that pick tire 50 has accumulated an unacceptable amount of debris such that a pick tire cleaning operation is warranted. Thus, controller 70 may initiate a pick tire cleaning operation (or issue a command to perform a pick tire cleaning operation at a later time).

In some examples, controller 70 may measure or detect the torque experienced by pick tire 50 without a torque sensor. For instance, in some examples, controller 70 may monitor the electrical signal (or some characteristic feature thereof, such as, for instance, voltage, current, etc.) supplied to a motor that is driving rotation of the pick tire 50 at a desired rotational speed during operations. The characteristics of the electrical signal to achieve or maintain the desired rotational speed of the pick tire 50 (e.g., again current, voltage, etc.) may provide an indication of the torque experienced by the pick tire 50 during operations. Therefore, in some examples, the value of torque (or a value or values that are indicative thereof) may serve as a pick tire condition parameter.

In some examples, a pick tire condition parameter may comprise a value or measurement representing the advancement of print media 23 along the print media path 24. For instance, without being limited to this or any other theory, during a printing operation, one may presume that each revolution (or partial revolution) of pick tire 50 may result in a corresponding distance of travel for the print media 23 (e.g., toward the second rollers 60, 62) along the print media path 24. If the frictional forces between the pick tire 50 and print media 23 have been sufficiently diminished (e.g., due to the accumulation of debris on the pick tire 50), then slippage may occur as described above, so that a given movement or rotation of the pick tire 50 may result in a less-than-expected movement of the print media 23 along print media path 24. Thus, in some examples, controller 70 may be coupled to a sensor or sensors for sensing a presence of print media 23 with the printer 10 at a particular location along print media path 24. In particular, in some examples, controller 70 may be coupled to a pair of sensors 54, 56 for detecting a presence of print media 23 at a location along the print media path 24, between the pick tire 50 and second rollers 60, 62. By comparing the current position of print media 23 (e.g., via sensors 54, 56) within printer 10 against the known or measured revolutions or movements of pick tire 50, controller 70 may then determine whether a pick tire cleaning operation is warranted.

In some examples, sensor 54 and/or sensor 56 may comprise an optical or light sensor. Specifically, in some examples, sensor 54 may comprise a light transmitter that is to generate light beam 55 and direct it toward sensor 56 which may comprise a receiver. During operations, as print media 23 is moved between the sensors 54, 56, the light beam 55 is effectively blocked from reaching sensor 56.

In some examples, sensor 54 may comprise a transceiver and sensor 56 may be replaced with a reflective surface, such that sensor 54 is to generate and emit the light beam 55 that is then reflected off of the reflective surface (not shown) disposed in place of sensor 56 so as to be received by the sensor 54. In these examples, the movement of print media 23 between sensor 54 and the reflective surface (not shown) may again prevent the light beam 55 from being reflected back and received by sensor 54.

While not specifically shown, the sensor 54 and/or sensor 56 may be coupled to controller 70 so that output signals produced by sensor 54 and/or sensor 56 may be communicated to controller 70 during operations. The coupling between the sensors 54, 56 and controller 70 is not specifically shown in FIG. 1 so as to simplify the drawing.

Still other examples of pick tire condition parameters may be utilized by controller 70 in various implementations so as to determine when to perform a pick tire cleaning operation. In some examples, a combination of pick tire condition parameters may be utilized by the controller 70 to determine when to perform a pick tire cleaning operation. In some examples, a pick tire condition parameter (or combination thereof) may be used by controller 70 to determine a feature (or plurality of features) of the pick tire cleaning operation as described in more detail below.

In some examples, the controller 70 may monitor the pick tire condition parameter (or a combination of pick tire condition parameters) during printing operations, If the pick tire condition parameter (or combination of pick tire condition parameters) crosses or passes a predetermined threshold, controller 70 may then determine that a pick tire cleaning operation is warranted. The threshold of the pick tire condition parameter (or plurality of pick tire condition parameters) may be defined so as to maintain an amount of debris accumulated on the pick tire 50 below some predetermined value, to maintain a desired frictional force between the pick tire 50 and print media 23, etc. Thus, the particular value of the threshold may vary depending on the particular pick tire condition being considered, as well as the design and arrangement of the pick tire 50, print media 23, and other components of printer 10.

Referring still to FIG. 1, during a pick tire cleaning operation, controller 70 may rotate pick tire 50 (via a motor or driver coupled thereto) so as to advance print media 23 from storage tray 20 to second rollers 60, 62. Controller 70 may also rotate second rollers 60, 62 (again, via a motor or driver coupled thereto) to feed or pinch print media 23 therebetween. Once the print media 23 is pinched by the second rollers 60, 62, controller 70 may stop the advancement of print media 23 by stopping the rotation of the second rollers 60, 62 (e.g., again by stopping a motor or motors coupled thereto). As a result, print media 23 may no longer be advanced along print media path 24, and may be effectively locked in place by the second rollers 60, 62. Thereafter, controller 70 may drive pick tire 50 to rotate (or continue rotating) on the print media 23. However, because the advancement of print media 23 is stopped via the second rollers 60, 62, this subsequent rotation of pick tire 50 may cause pick tire 50 to skid or slide relative to the print media 23 surface so as to effectively wipe the pick tire 50 along the print media 23 and thereby remove some or all of the debris that may have accumulated on the pick tire 50. After a predetermined number of revolutions of the pick tire 50 are completed against the stopped print media 23, the controller 70 may once again rotate the second rollers 60, 62 to continue the advance of print media 23 along print media path 24 toward printing assembly 30.

In some examples, the pick tire 50 may be rotated in the same direction during both a pick tire cleaning operation and when advancing print media 23 from the storage tray 20. As a result, in some examples, the distance between the pick tire 50 and second rollers 60, 62 along the print media path 24 may be chosen so as to achieve a sufficient stiffness of the print media 23 between pick tire 50 and second rollers 60, 62 for preventing buckling of the print media 23 (e.g., between the pick tire 50 and second rollers 60, 62) during the pick tire cleaning operation. Without being limited to this or any other theory, rotating the pick tire 50 in the same directions during both a pick tire cleaning operation and print media advancement may allow for a relatively simple drive assembly (e.g., motors, gears, shafts, etc.) for rotating the pick tire 50 in one direction.

Alternatively, in some examples, the pick tire 50 may be rotated in an opposite direction during a pick tire cleaning operation as compared to when the pick tire 50 is rotated to advance print media 23 from storage tray 20. Without being limited to this or any other theory, by rotating the pick tire 50 in an opposite direction (e.g., opposite from the rotation direction of the pick tire 50 during advancement of print media 23 from storage tray 20), the print media 23 may be placed in tension between the pick tire 50 and second rollers 60, 62 during a pick tire cleaning operation so as to prevent buckling of the print media 23.

In some examples, the pick tire 50 may be rotated faster or slower during a pick tire cleaning operation as compared to during advancement of print media 23 from storage tray 20. Alternatively, the pick tire 50 may be rotated the same speed during both a pick tire cleaning operation and during advancement of print media 23 from storage tray 20.

Accordingly, in some examples, the pick tire cleaning operation is associated with an advance of the print media 23 along print media path 24 so that a pick tire cleaning operation may be performed as part of a printing operation as generally described above. Indeed, in some examples, the pick tire cleaning operation may be performed at the beginning of a printing operation, such as at the beginning of a printing operation after (e.g., immediately after in some instances) a determination by the controller 70 (e.g., via a pick tire condition parameter as previously described) that a pick tire cleaning operation is warranted. In some examples, controller 70 may assess whether a pick tire cleaning operation is warranted (e.g., via a pick tire condition parameter) at a beginning of a print job (e.g., such as during an initial portion of a page pick by the pick tire 50), and then perform the pick tire cleaning operation as described above during that same print job (e.g., such as during a latter portion of the page pick).

In some examples, the advancement of print media 23 may be stopped during a pick tire cleaning operation (e.g., via controller 70) in a number of different manners either in addition to or in lieu of stopping second rollers 60, 62 as described above. For instance, in some examples, a frame or other mechanism may be moved into engagement with the print media 23 so as to prevent further advancement thereof. Thus, it is contemplated that various methods and mechanisms may be used in various examples to stop the advancement of print media 23 along print media path 24 during a pick tire cleaning operation.

In some examples, the print media path 24 may flip the print media 23 so as that the pick tire cleaning operation occurs on a first side of the print media 23, and then the subsequent printing via the printing assembly 30 places images on a second side of the print media 23 that is opposite the first side. Specifically, in some examples, the pick tire cleaning operation described above may result in skids, lines, or other marks being deposited on the print media 23 (e.g., as a result of skidding or wiping the pick tire 50 along the print media 23). Depending on the amount of debris disposed on the pick tire 50, as well as the type of print job being performed (e.g., low quality, high quality, photo print, document print, etc.) the presence of these marks may be unacceptable to a user. Thus, by performing the pick tire cleaning operation (i.e., rotating the pick tire 50 on stopped print media 23) on a first side of the print media 23 and then performing the printing operation on a second side (which is opposite the first side) of the print media 23, the presence of undesirable markings on the side of print media bearing the printed images may be avoided.

However, in some examples, the pick tire cleaning operation (i.e., the rotation of the pick tire 50 on stopped print media 23) and the printing operation may be performed on the same side of the print media 23. For instance, in some examples, the print media path 24 may present the same side of print media 23 (e.g., a first side) to both the pick tire 50 and the printing assembly 30. In addition, in some instances, the printer 10 may perform two-sided printing, whereby printing assembly 30 is utilized to print images on both sides of print media 23.

As described above, it may be considered undesirable for the pick tire 50 to leave lines or other marks on the print media 23 during a printing operation, and that the performance of the above-described pick tire cleaning operation may result in such marks on the print media 23. However, because controller 70 actively monitors the pick tire condition (e.g., via a pick tire condition parameter as described above), pick tire cleaning operations may be carried out with enough frequency and in a proactive manner so as to prevent large amount of debris from accumulating on the pick tire 50 through the operational life of the printer 10. As a result, while the performance of pick tire cleaning operation may result in marks on the print media as noted above, these marks may be minor in nature due to a generally reduced amount of accumulated debris on the pick tire 50 overall, such that they do not degrade (or sufficiently degrade) the quality of the images subsequently printed by printing assembly 30.

In addition, controller 70 may condition the performance of a pick tire cleaning operation based on the specifications or features of the particular print job. For instance, if a user has selected a higher quality or resolution (e.g., dots per inch) for the print job, has selected a higher quality print media (e.g., card-stock, photo media, etc.), or has made any other selection so as to indicate a higher quality print job, controller 70 may prevent the performance of the pick tire cleaning operation, even if a pick tire condition parameter may otherwise indicate that a pick tire cleaning operation is warranted. Thus, in some examples, controller 70 may prevent the performance of a pick tire cleaning operation for print jobs wherein marks from the pick tire 50 may be particularly undesirable. In some examples, the controller 70 may initiate a pick tire cleaning operation on a piece of print media 23 that may be designated as a status or maintenance page that is not otherwise used within a particular print job.

Referring still to FIG. 1, in some examples controller 70 may alter, select, adjust, etc. a feature (or plurality of features) of the pick tire cleaning operation based on a known or presumed amount of accumulated debris on pick tire 50. For instance, in some examples, controller 70 may adjust a number of rotations of pick tire 50 on the stopped print media 23 (e.g., a “feature” of the pick tire cleaning operation) based on a known or presumed amount of accumulated debris on pick tire 50. In some examples, controller 70 may adjust an engagement force between the pick tire 50 and print media 23 (or pad 110) (e.g., another “feature” of the pick tire cleaning operation) via any suitable structure or mechanism, based on a known or presumed amount of accumulated debris on pick tire 50. For instance, in some examples, the pick tire 50 may be biased into engagement with the print media 23 via an arm, shaft, or other structure, which may be actuated by a driver (e.g., electric motor). Thus, during operations, controller 70 may actuate this other driver (or drivers) (not shown) so as to adjust an engagement force or pressure applied to the print media 23 via the pick tire 50.

Generally speaking, as the amount of debris accumulated on the pick tire 50 (e.g., as determined based on a pick tire condition parameter) increases, the number of revolutions performed by the pick tire 50 and/or the engagement force between the pick tire 50 and print media 23 (or pad 110) during a pick tire cleaning operation may also be increased. In some examples, the amount of accumulated debris on pick tire 50 may be determined or estimated based on a pick tire condition parameter (or combination of pick tire condition parameters as previously described above).

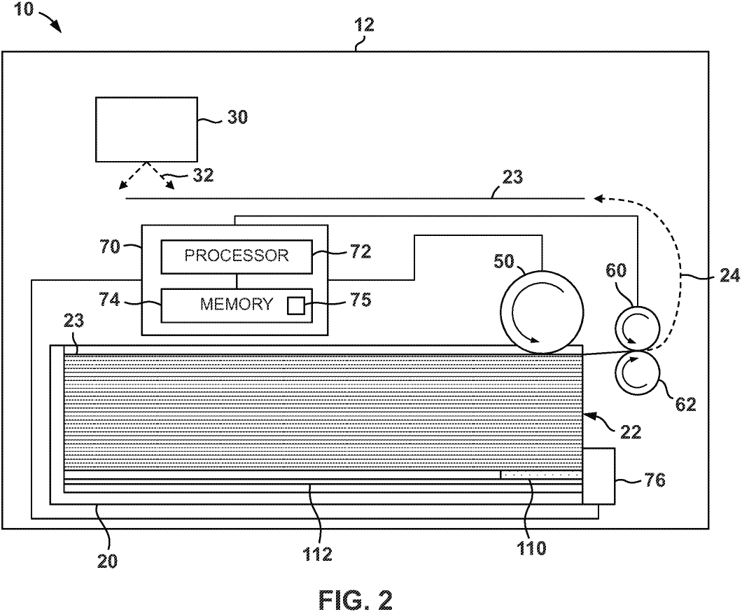

Referring now to FIG. 2, in some examples, a pad 110 may be disposed within storage tray 20. Pad 110 may comprise a so-called cork pad that is to provide a desired frictional contact with a lower most piece of print media 23 within stack 22 so as to prevent multiple pieces (e.g., pages) of print media 23 from being picked by pick tire 50 as the stack 22 of print media 23 becomes depleted (e.g., when relatively few pieces of print media 23 remain within stack 22).

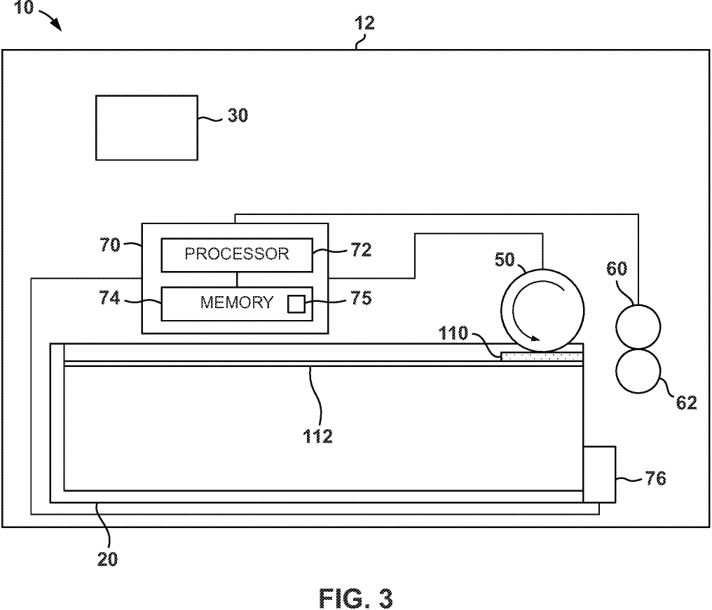

In addition, in some examples, pad 110 may also be used to perform a pick tire cleaning operation either in addition to or in lieu of the pick tire cleaning operations previously described above (e.g., a pick tire cleaning on the print media 23 itself). Specifically, with reference now to FIG. 3, when storage tray 20 has been emptied of all print media 23, controller 70 may drive pick tire 50 to rotate against pad 110 so as to clean pick tire 50 in generally the manner described above. However, in these examples, the controller 70 may perform a relatively aggressive cleaning (e.g., a greater number of revolutions of pick tire 50, a greater engagement force between the pick tire 50 and pad 110, etc.) than may be employed for a pick tire cleaning operation on the print media 23. In some examples, a pick tire cleaning operation against the pad 110 may be performed as a result of a pick tire condition parameter as previously described above; however, in some of these examples, the threshold for the pick tire condition parameter that may be applied by the controller 70 to initiate a pick tire cleaning operation against pad 110 may be set so as to correspond with a situation where pick tire 50 has accumulated a relatively large amount of debris. In some instances, the controller 70 may initiate a pick tire cleaning operation against the pad 110 after a predetermined number of pick tire cleaning operations against the print media 23.

As shown in FIG. 3, in some examples, storage tray 20 may include a lower support surface 112 that is to move upward toward pick tire 50 (e.g., via spring pressure, or other suitable mechanism(s)) as the stack 22 of print media 23 is reduced. As a result, when the print media 23 is emptied from storage tray 20, the lower support surface 112 may move upward sufficiently to engage pad 110 with pick tire 50 as previously described above. In addition, in some examples, the pick tire 50 may be movable relative to the storage tray 20. For instance, pick tire 50 may be biased downward into engagement with print media 23 within storage tray 20, so that when the stack 22 of print media 23 is depleted and the storage tray 20 is empty, the pick tire 50 may be biased into engagement with the pad 110 that is disposed along the bottom surface of storage tray 20.

In some examples, controller 70 may condition cleaning the pick tire 50 against the pad 110 based on determining that the storage tray 20 is empty (i.e., contains no print media 23 therein). For instance, in some examples, a level sensor 76 may be coupled to (and/or disposed within) the storage tray 20 that may detect the amount of print media 23 within storage tray 20 (or simply whether any print media 23 is present within storage tray 20). Thus, in some examples, controller 70 may condition the performance of a pick tire cleaning operation against the pad 110 on the output of the sensor 76 (i.e., whether the storage tray 20 is empty).

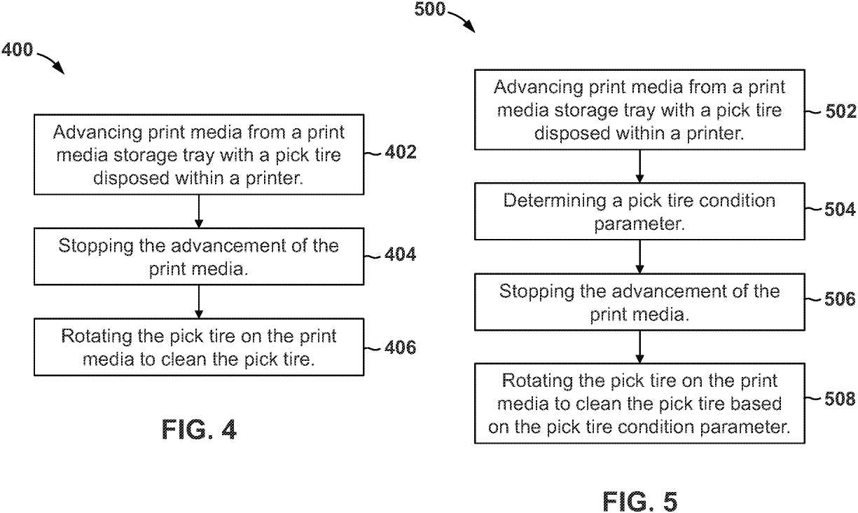

Referring now to FIG. 4, a method 400 of cleaning a pick tire of a printer according to some examples is shown. In some examples, method 400 may be performed via printer 10. Thus, in describing the method 400, reference will be made to the printer 10 and various features thereof which are previously described above, so as to better illustrate some example implementations of method 400.

Initially, method 400 includes advancing print media from a print media storage tray within a pick tire disposed within a printer at block 402. For instance, for the printer 10 (see e.g., FIG. 1), print media 23 may be advanced out of storage tray 20 via pick tire 50 as previously described above.

Method 400 next includes stopping the advancement of the print media at block 404. For instance, for the printer 10 (see e.g., FIG. 1), the advancement of print media 23 from storage tray 20 through print media path 24 may be stopped by engaging and pinching the print media 23 between second rollers 60, 62 and then stopping the rotation of second rollers 60, 62 (e.g., via controller 70). In some examples, other methods of stopping the advance of print media 23 within printer 10 may be performed such as those previously described above.

Method 400 next includes rotating the pick tire on the print media to clean the pick tire at block 406. For instance, for the printer 10 (see e.g., FIG. 1) once the advancement of print media 23 along the print media path 24 is stopped (e.g., via stopping second rollers 60, 62, and/or some other mechanism or manner as described above), the pick tire 50 may be rotated relative to the print media 23 so as to wipe the pick tire 50 against the print media 23 and therefore clean debris therefrom.

Referring now to FIG. 5, a method 500 of cleaning a pick tire of a printer according to some examples is shown. In some examples, method 500 may be performed via printer 10. Thus, in describing the method 500, reference will be made to the printer 10 and various features thereof previously described above, so as to better illustrate some example implementations of method 500.

Initially, method 500 includes advancing print media from a print media storage tray with a pick tire disposed within a printer at block 502. In some examples, block 502 may be carried out per the description given above for block 402 of method 400 in FIG. 4, and thus, this description is not repeated in the interests of brevity.

Next, method 500 includes determining a pick tire condition parameter at block 504. For instance, a pick tire condition parameter in block 504 may comprise any of the example pick tire condition parameters previously described above, including combinations thereof. As previously described for printer 10 of FIG. 1, a pick tire condition parameter may be analyzed to determine whether the pick tire condition parameter (e.g., a number of print jobs, a number of page picks, a torque transferred to the pick tire 50 during a page pick, a movement of print media 23 per revolution of the pick tire 50, etc.) has passed a predetermined threshold.

Referring again to FIG. 5, next, method 500 includes stopping the advancement of the print media at block 506. In some examples, block 506 may be carried out per the description given above for block 404 of method 400 in FIG. 4, and thus, this description is not repeated in the interests of brevity.

Next, method 500 includes rotating the pick tire on the print media to clean the pick tire based on the pick tire condition parameter at block 508. For instance, rotating the pick tire against the print media may generally be carried out per the description given above for block 406 of method 400 in FIG. 4. However, in addition, block 508 also includes rotating the pick tire on the print media based on the pick tire condition parameter. For instance, basing the rotating of the pick tire on the print media at block 508 may comprise determining whether a pick tire condition parameter (or combination of pick tire condition parameters) has passed a threshold in the manner previously described above for printer 10 (see e.g., FIG. 1). Method 500 may also comprise basing stopping the advancement of the print media at block 506 on the pick tire condition parameter as described above.

In some examples, basing the rotating of the pick tire on the print media at block 508 may comprise selecting or adjusting a feature of the pick tire rotation at block 508 (e.g., such as a number of rotations of pick tire, an engagement force between the pick tire and print media, etc.) based on a pick tire condition parameter (or combination of pick tire condition parameters) passing a threshold such as is also described above for printer 10 (see e.g., FIG. 1).

Referring now to FIGS. 4 and 5, in some examples, methods 400, 500 may also include emptying the print media storage tray, and then rotating the pick tire on a pad disposed within the print media storage tray. For instance, as previously described above for the printer 10 and shown in FIGS. 2 and 3, the pick tire 50 may be rotated on pad 110 within storage tray 20 when all print media 23 has been removed from storage tray 20.

In addition, in some examples, methods 400, 500 may include rotating the pick tire on a first side of the print media (e.g., at blocks 406, 508) and then printing an image (e.g., via printing assembly 30 shown in FIG. 1) on a second side of the print media that is opposite the first side. Further, in some examples, methods 400, 500 may include rotating the pick tire on a first side of the print media (e.g., at blocks 406, 508) and then printing an image on the first side of the print media.

As described herein, the examples disclosed herein include systems and related methods for cleaning a pick tire (e.g., pick tire 50). In some examples, the systems and methods may determine a pick tire condition parameter, and then, based on the pick tire condition parameter, initiate a cleaning operation whereby the pick tire is intentionally rotated along a surface of the print media so as to remove debris from the pick tire. Thus, through use of the examples disclosed herein, a pick tire may be regularly cleaned so as to maintain an acceptable coefficient of friction for the pick tire, and to avoid un-controlled marking (e.g., with debris from the pick tire) of the print media during printing operations.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to .. .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “lateral” and “laterally” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A method, comprising:
advancing print media from a print media storage tray with a pick tire disposed within a printer;
stopping the advancement of the print media; and then
rotating the pick tire on the print media to clean the pick tire.

2. The method of claim 1, wherein stopping the advancement of the print media comprises:
engaging the print media with a second roller within the printer; and
preventing the rotation of the second roller.

3. The method of claim 1, comprising printing an image on the print media after rotating the pick tire on the print media.

4. The method of claim 3, wherein rotating the pick tire on the print media comprises rotating the pick tire on a first side of the print media, and wherein printing the image comprises printing the image on a second side of the print media that is opposite the first side.

5. The method of claim 3, wherein rotating the pick tire on the print media comprises rotating the pick tire on a first side of the print media, and wherein printing the image comprises printing the image on the first side of the print media.

6. The method of claim 1, comprising:
emptying the print media storage tray; and
rotating the pick tire on a pad disposed in the print media storage tray.

7. The method of claim 1, comprising:
detecting a pick tire condition parameter; and
wherein rotating the pick tire on the print media comprises rotating the pick tire when the pick tire condition parameter passes a threshold.

8. A printer, comprising:
a print media storage tray to hold print media;
a printing assembly to print images on the print media;
a pick tire to advance the print media from the print media storage tray toward the printing assembly; and
a controller coupled to the pick tire, wherein the controller is to:
advance print media from the print media storage tray with the pick tire;
determine a pick tire condition parameter;
stop the advancement of the print media; and
rotate the pick tire on the print media after stopping the advancement, to clean the pick tire based on the pick tire condition parameter.

9. The printer of claim 8, wherein the controller is to advance the print media to the printing assembly after rotating the pick tire on the print media.

10. The printer of claim 9, wherein the controller is to rotate the pick tire on a first side of the print media to clean the pick tire, and wherein the printing assembly is to print an image on a second side of the print media that is opposite the first side.

11. The printer of claim 9, wherein the controller is to rotate the pick tire on a first side of the print media to clean the pick tire, and wherein the printing assembly is to print an image on the first side of the print media.

12. The printer of claim 8, wherein the controller is to:
determine that the pick tire condition parameter has passed a threshold; and
rotate the pick tire on the print media to clean the pick tire based on the determination that the pick tire condition parameter has passed the threshold.

13. A non-transitory machine-readable medium including instructions that, when executed by a processor, cause the processor to:
advance print media within a printer from a print media storage tray with a pick tire;
stop the advancement of the print media; and then
rotate the pick tire on the print media to clean the pick tire.

14. The non-transitory machine-readable medium of claim 13, wherein the instructions, when executed by the processor, cause the processor to advance the print media to a printing assembly after rotating the pick tire on the print media.

15. The non-transitory machine-readable medium of claim 14, wherein the instructions, when executed by the processor, cause the processor to rotate the pick tire on the print media based on detecting that a pick tire condition parameter has passed a threshold.
